(19) United States
(12) Patent Application Publication
(10) Pub. No.: US 2012/0050570 A1
(43) Pub. Date: Mar. 1, 2012

(54) AUDIO PROCESSING BASED ON SCENE TYPE

(76) Inventors: David W. Jasinski, Rochester, NY (US); Wayne E. Prentice, Honeoye Falls, NY (US); Keith A. Jacoby, Rochester, NY (US); John P. Spence, Webster, NY (US)

(21) Appl. No.: 12/869,040

(22) Filed: Aug. 26, 2010

(51) Int. Cl. H04N 5/76

(52) U.S. Cl. 348/231.4; 348/E05.024

(57) ABSTRACT

A digital camera system providing processed audio signals, comprising: an image sensor for capturing a digital image; an optical system for forming an image of a scene onto the image sensor; a microphone for capturing an audio signal; a data processing system; a storage memory for storing captured images and audio signals; and a program memory communicatively connected to the data processing system and storing instructions configured to cause the data processing system to implement a method for providing processed audio signals, wherein the instructions include: capturing one or more digital images of a scene using the image sensor and capturing a corresponding audio signal using the microphone; determining a scene type corresponding to the captured digital images; processing the captured audio signal responsive to the determined scene type; and recording the captured digital images together with the processed audio signal in the storage memory.

### FIELD OF THE INVENTION

This invention pertains to the field of audio signal processing, and more particularly to a method for audio signal processing in a digital camera based on a detected scene type.

### BACKGROUND OF THE INVENTION

Many digital cameras include a microphone that can be used to capture an audio signal. The audio signal can be used to create an audio track that can be associated with a video sequence or a still image captured by the digital camera.

Various methods for processing audio signals are known to those skilled in the art. Such processing methods often include applying processing steps such as signal amplification, noise reduction, spectral filtering, signal compression and audio file formatting. It is known that different types of audio processing are better suited to different types of audio signals. For example, audio processing that is well-suited for audio signals containing music may produce sub-optimal results for audio signals containing speech, or audio signals recorded in a windy outdoors environment. However, for reasons of system simplicity, digital cameras commonly include a single audio processing path which represents a compromise between the various types of audio signals that are likely to be encountered.

Some digital cameras include an optional “wind noise” audio processing path optimized for high wind conditions. In some embodiments, the wind noise audio processing path simply lowers the audio signal level in an attempt to muffle the wind noise and reduce clipping. In other embodiments, electronic audio equalization is used to suppress spectral frequencies associated with the wind noise so that other sounds are more pronounced. Some cameras include a user interface that can be used to manually select the wind noise audio processing path when the camera is being operated in high wind conditions. In some cases, the cameras automatically switch to the wind noise audio processing path when they detect that the spectral content of the audio signal contains both frequencies characteristic of wind noise as well as frequencies characteristic of a typical human voice.

U.S. Pat. No. 7,684,982 to Taneda, entitled “Noise reduction and audio-visual speech activity detection,” discloses an imaging device that performs noise reduction based on automatic speech activity recognition. A dynamic adaptive noise reduction technique is applied which is synchronized with a speaker's facial movements. The speech activity recognition system extracts visual features from a digital video sequence by analyzing facial expressions. Audio features are also extracted from an analog audio sequence. The extracted visual features and audio features are fed to a noise reduction circuit which adaptively processes the recorded audio signal to increase the signal-to-interference ratio.

### SUMMARY OF THE INVENTION

The present invention represents a digital camera system providing processed audio signals, comprising:

an image sensor for capturing a digital image;

an optical system for forming an image of a scene onto the image sensor;

a microphone for capturing an audio signal;

a data processing system;

a storage memory for storing captured images and audio signals; and

a program memory communicatively connected to the data processing system and storing instructions configured to cause the data processing system to implement a method for providing processed audio signals, wherein the instructions include:
capturing one or more digital images of a scene using the image sensor and capturing a corresponding audio signal using the microphone;
determining a scene type corresponding to the captured digital images;
processing the captured audio signal responsive to the determined scene type; and
recording the captured digital images together with the processed audio signal in the storage memory.

This invention has the advantage that it provides audio processing that is optimized according to the acoustic properties of the recording environments associated with different scene types. In this way a processed audio signal is produced having an improved audio quality.

It has the additional advantage that it provides digital videos having improved audio quality by adjusting the audio processing on a scene-by-scene basis on the basis of the scene type.

### BRIEF DESCRIPTION OF THE DRAWINGS

FIG. 1 is a high-level diagram showing the components of a digital camera system;

FIG. 2 is a flow diagram depicting typical image processing operations used to process digital images in a digital camera;

FIG. 3 is a flow diagram depicting typical audio processing operations used to process audio signals captured in a digital camera; and

FIG. 4 is a flow diagram depicting a method for processing audio signals captured in a digital camera according to a preferred embodiment of the present invention.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Because digital cameras employing imaging devices and related circuitry for signal capture and processing, and display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The following description of a digital camera will be familiar to one skilled in the art. It will be obvious that there are many variations of this embodiment that are possible and are selected to reduce the cost, add features or improve the performance of the camera.

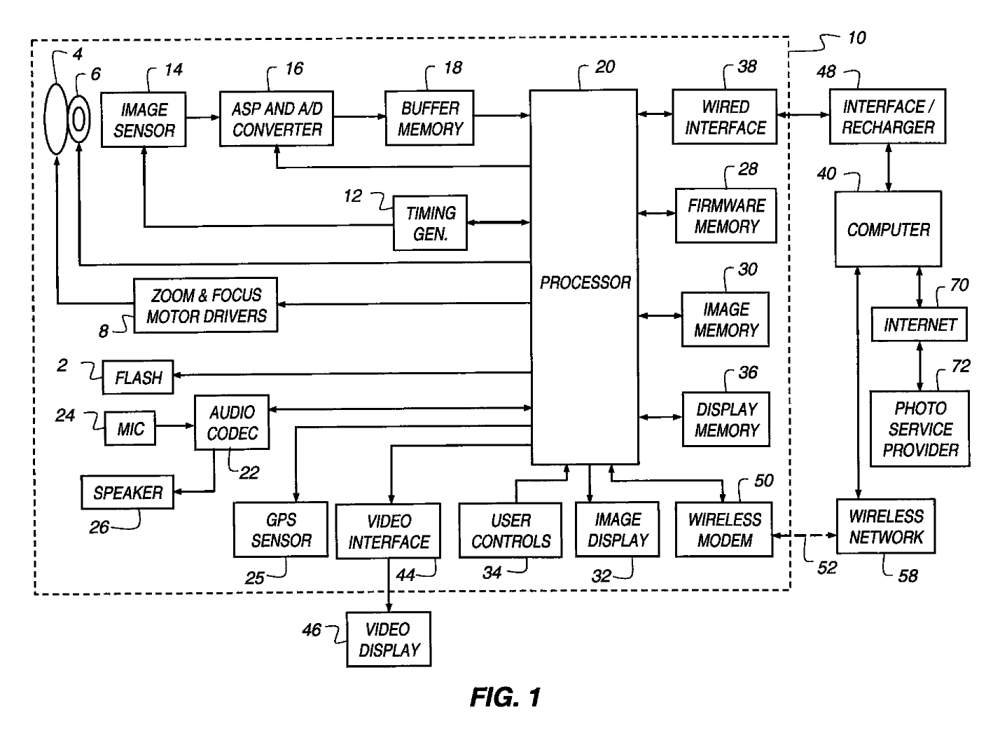

FIG. 1 depicts a block diagram of a digital photography system, including a digital camera 10 in accordance with the present invention. Preferably, the digital camera 10 is a portable battery operated device, small enough to be easily handheld by a user when capturing and reviewing images. The digital camera 10 produces digital images that are stored as digital image files using image memory 30. The phrase “digital image” or “digital image file”, as used herein, refers to any digital image file, such as a digital still image or a digital video file.

In some embodiments, the digital camera 10 captures both motion video images and still images. The digital camera 10 can also include other functions, including, but not limited to, the functions of a digital music player (e.g. an MP3 player), a mobile telephone, a GPS receiver, or a programmable digital assistant (PDA).

The digital camera 10 includes a lens 4 having an adjustable aperture and adjustable shutter 6. In a preferred embodiment, the lens 4 is a zoom lens and is controlled by zoom and focus motor drives 8. The lens 4 focuses light from a scene (not shown) onto an image sensor 14, for example, a single-chip color CCD or CMOS image sensor. The lens 4 is one type optical system for forming an image of the scene on the image sensor 14. In other embodiments, the optical system may use a fixed focal length lens with either variable or fixed focus.

The output of the image sensor 14 is converted to digital form by Analog Signal Processor (ASP) and Analog-to-Digital (A/D) converter 16, and temporarily stored in buffer memory 18. The image data stored in buffer memory 18 is subsequently manipulated by a processor 20, using embedded software programs (e.g. firmware) stored in firmware memory 28. In some embodiments, the software program is permanently stored in firmware memory 28 using a read only memory (ROM). In other embodiments, the firmware memory 28 can be modified by using, for example, Flash EPROM memory. In such embodiments, an external device can update the software programs stored in firmware memory 28 using the wired interface 38 or the wireless modem 50. In such embodiments, the firmware memory 28 can also be used to store image sensor calibration data, user setting selections and other data which must be preserved when the camera is turned off. In some embodiments, the processor 20 includes a program memory (not shown), and the software programs stored in the firmware memory 28 are copied into the program memory before being executed by the processor 20.

It will be understood that the functions of processor 20 can be provided using a single programmable processor or by using multiple programmable processors, including one or more digital signal processor (DSP) devices. Alternatively, the processor 20 can be provided by custom circuitry (e.g., by one or more custom integrated circuits (ICs) designed specifically for use in digital cameras), or by a combination of programmable processor(s) and custom circuits. It will be understood that connectors between the processor 20 from some or all of the various components shown in FIG. 1 can be made using a common data bus. For example, in some embodiments the connection between the processor 20, the buffer memory 18, the image memory 30, and the firmware memory 28 can be made using a common data bus.

The processed images are then stored using the image memory 30. It is understood that the image memory 30 can be any form of memory known to those skilled in the art including, but not limited to, a removable Flash memory card, internal Flash memory chips, magnetic memory, or optical memory. In some embodiments, the image memory 30 can include both internal Flash memory chips and a standard interface to a removable Flash memory card, such as a Secure Digital (SD) card. Alternatively, a different memory card format can be used, such as a micro SD card, Compact Flash (CF) card, MultiMedia Card (MMC), xD card or Memory Stick.

The image sensor 14 is controlled by a timing generator 12, which produces various clocking signals to select rows and pixels and synchronizes the operation of the ASP and A/D converter 16. The image sensor 14 can have, for example, 12.4 megapixels (4088×3040 pixels) in order to provide a still image file of approximately 4000×3000 pixels. To provide a color image, the image sensor is generally overlaid with a color filter array, which provides an image sensor having an array of pixels that include different colored pixels. The different color pixels can be arranged in many different patterns. As one example, the different color pixels can be arranged using the well-known Bayer color filter array, as described in commonly assigned U.S. Pat. No. 3,971,065, “Color imaging array” to Bayer, the disclosure of which is incorporated herein by reference. As a second example, the different color pixels can be arranged as described in commonly assigned U.S. Patent Application Publication 2007/0024931 to Compton and Hamilton, entitled “Image sensor with improved light sensitivity,”, the disclosure of which is incorporated herein by reference. These examples are not limiting, and many other color patterns may be used.

It will be understood that the image sensor 14, timing generator 12, and ASP and A/D converter 16 can be separately fabricated integrated circuits, or they can be fabricated as a single integrated circuit as is commonly done with CMOS image sensors. In some embodiments, this single integrated circuit can perform some of the other functions shown in FIG. 1, including some of the functions provided by processor 20.

The image sensor 14 is effective when actuated in a first mode by timing generator 12 for providing a motion sequence of lower resolution sensor image data, which is used when capturing video images and also when previewing a still image to be captured, in order to compose the image. This preview mode sensor image data can be provided as HD resolution image data, for example, with 1280×720 pixels, or as VGA resolution image data, for example, with 640×480 pixels, or using other resolutions which have significantly fewer columns and rows of data, compared to the resolution of the image sensor.

The preview mode sensor image data can be provided by combining values of adjacent pixels having the same color, or by eliminating some of the pixels values, or by combining some color pixels values while eliminating other color pixel values. The preview mode image data can be processed as described in commonly assigned U.S. Pat. No. 6,292,218 to Parulski, et al., entitled “Electronic camera for initiating capture of still images while previewing motion images,” which is incorporated herein by reference.

The image sensor 14 is also effective when actuated in a second mode by timing generator 12 for providing high resolution still image data. This final mode sensor image data is provided as high resolution output image data, which for scenes having a high illumination level includes all of the pixels of the image sensor, and can be, for example, a 12 megapixel final image data having 4000×3000 pixels. At lower illumination levels, the final sensor image data can be provided by “binning” some number of like-colored pixels on the image sensor, in order to increase the signal level and thus the “ISO speed” of the sensor.

The zoom and focus motor drivers 8 are controlled by control signals supplied by the processor 20, to provide the appropriate focal length setting and to focus the scene onto the image sensor 14. The exposure level of the image sensor 14 is controlled by controlling the f/number and exposure time of the adjustable aperture and adjustable shutter 6, the exposure period of the image sensor 14 via the timing generator 12, and the gain (i.e., ISO speed) setting of the ASP and A/D converter 16. The processor 20 also controls a flash 2 which can illuminate the scene.

The lens 4 of the digital camera 10 can be focused in the first mode by using “through-the-lens” autofocus, as described in commonly-assigned U.S. Pat. No. 5,668,597, entitled “Electronic Camera with Rapid Automatic Focus of an Image upon a Progressive Scan Image Sensor” to Parulski et al., which is incorporated herein by reference. This is accomplished by using the zoom and focus motor drivers 8 to adjust the focus position of the lens 4 to a number of positions ranging between a near focus position to an infinity focus position, while the processor 20 determines the closest focus position which provides a peak sharpness value for a central portion of the image captured by the image sensor 14. The focus distance which corresponds to the closest focus position can then be utilized for several purposes, such as automatically setting an appropriate scene mode, and can be stored as metadata in the image file, along with other lens and camera settings.

The processor 20 produces menus and low resolution color images that are temporarily stored in display memory 36 and are displayed on the image display 32. The image display 32 is typically an active matrix color liquid crystal display (LCD), although other types of displays, such as organic light emitting diode (OLED) displays, can be used. A video interface 44 provides a video output signal from the digital camera 10 to a video display 46, such as a flat panel HDTV display. In preview mode, or video mode, the digital image data from buffer memory 18 is manipulated by processor 20 to form a series of motion preview images that are displayed, typically as color images, on the image display 32. In review mode, the images displayed on the image display 32 are produced using the image data from the digital image files stored in image memory 30.

The graphical user interface displayed on the image display 32 is controlled in response to user input provided by user controls 34. The user controls 34 are used to select various camera modes, such as video capture mode, still capture mode, and review mode, and to initiate capture of still images, recording of motion images. The user controls 34 are also used to set user processing preferences, and to choose between various photography modes based on scene type and taking conditions. In some embodiments, various camera settings may be set automatically in response to analysis of preview image data, audio signals, or external signals such as GPS, weather broadcasts, or other available signals. For example, U.S. Patent Application Publication 2009/0160968 to Prentice et al., entitled “Camera using preview image to select exposure,” teaches that exposure and tone scale processing can be adjusted dependent upon features extracted from preview image data.

In some embodiments, when the digital camera is in a still photography mode the preview mode is initiated when the user partially depresses a shutter button, which is one of the user controls 34, and the still image capture mode is initiated when the user fully depresses the shutter button. The user controls 34 are also used to turn on the camera, control the lens 4, and initiate the picture taking process. User controls 34 typically include some combination of buttons, rocker switches, joysticks, or rotary dials. In some embodiments, some of the user controls 34 are provided by using a touch screen overlay on the image display 32. In other embodiments, the user controls 34 can include a means to receive input from the user or an external device via a tethered, wireless, voice activated, visual or other interface. In other embodiments, additional status displays or images displays can be used.

The camera modes that can be selected using the user controls 34 include a “timer” mode. When the “timer” mode is selected, a short delay (e.g., 10 seconds) occurs after the user fully presses the shutter button, before the processor 20 initiates the capture of a still image.

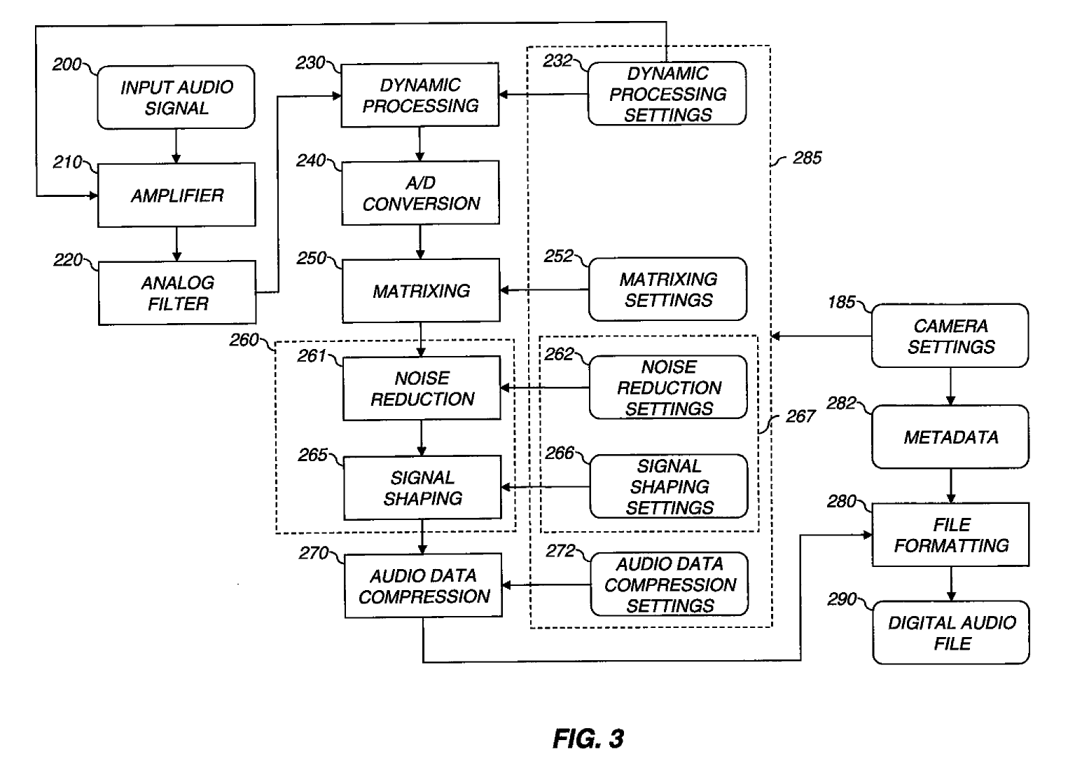

An optional global position system (GPS) sensor 25 on the digital camera 10 can be used to provide geographical location information which is used for implementing the present invention, as will be described later with respect to FIG. 3. GPS sensors 25 are well-known in the art and operate by sensing signals emitted from GPS satellites. A GPS sensor 25 receives highly accurate time signals transmitted from GPS satellites. The precise geographical location of the GPS sensor 25 can be determined by analyzing time differences between the signals received from a plurality of GPS satellites positioned at known locations.

An audio codec 22 connected to the processor 20 receives an audio signal from a microphone 24 and provides an audio signal to a speaker 26. These components can be used to record and playback an audio track, along with a video sequence or still image. If the digital camera 10 is a multi-function device such as a combination camera and mobile phone, the microphone 24 and the speaker 26 can be used for telephone conversation.

In some embodiments, the speaker 26 can be used as part of the user interface, for example to provide various audible signals which indicate that a user control has been depressed, or that a particular mode has been selected. In some embodiments, the microphone 24, the audio codec 22, and the processor 20 can be used to provide voice recognition, so that the user can provide a user input to the processor 20 by using voice commands, rather than user controls 34. The speaker 26 can also be used to inform the user of an incoming phone call. This can be done using a standard ring tone stored in firmware memory 28, or by using a custom ring-tone downloaded from a wireless network 58 and stored in the image memory 30. In addition, a vibration device (not shown) can be used to provide a silent (e.g., non audible) notification of an incoming phone call.

The processor 20 also provides additional processing of the image data from the image sensor 14, in order to produce rendered sRGB image data which is compressed and stored within a “finished” image file, such as a well-known Exif-JPEG image file, in the image memory 30.

The digital camera 10 can be connected via the wired interface 38 to an interface/recharger 48, which is connected to a computer 40, which can be a desktop computer or portable computer located in a home or office. The wired interface 38 can conform to, for example, the well-known USB 2.0 interface specification. The interface/recharger 48 can provide power via the wired interface 38 to a set of rechargeable batteries (not shown) in the digital camera 10.

The digital camera 10 can include a wireless modem 50, which interfaces over a radio frequency band 52 with the wireless network 58. The wireless modem 50 can use various wireless interface protocols, such as the well-known Bluetooth wireless interface or the well-known 802.11 wireless interface. The computer 40 can upload images via the Internet 70 to a photo service provider 72, such as the Kodak EasyShare Gallery. Other devices (not shown) can access the images stored by the photo service provider 72.

In alternative embodiments, the wireless modem 50 communicates over a radio frequency (e.g. wireless) link with a mobile phone network (not shown), such as a 3GSM network, which connects with the Internet 70 in order to upload digital image files from the digital camera 10. These digital image files can be provided to the computer 40 or the photo service provider 72.

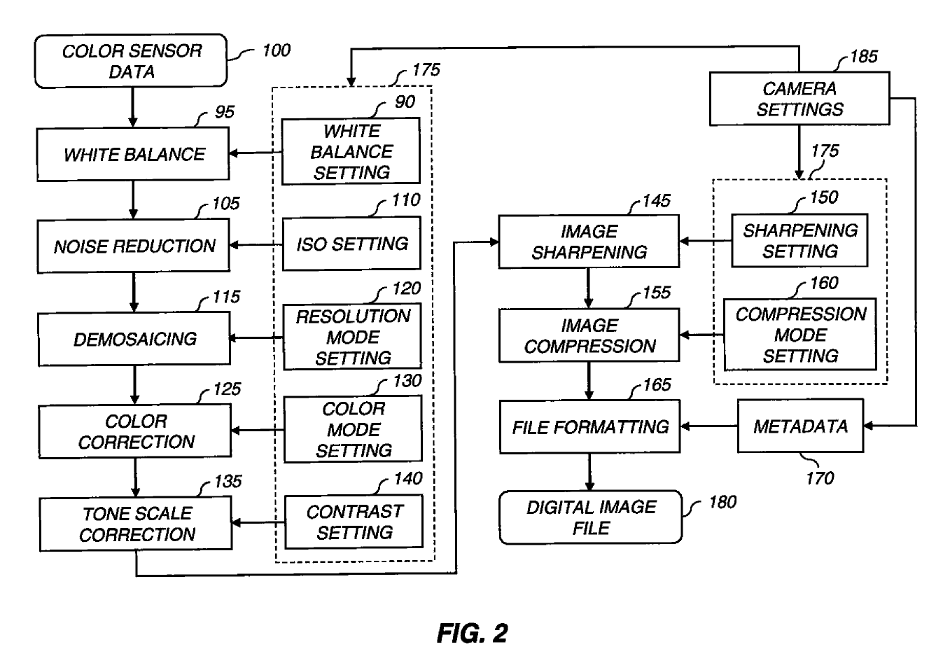

FIG. 2 is a flow diagram depicting image processing operations that can be performed by the processor 20 in the digital camera 10 (FIG. 1) in order to process color sensor data 100 from the image sensor 14 output by the ASP and A/D converter 16. In some embodiments, the processing parameters used by the processor 20 to manipulate the color sensor data 100 for a particular digital image are determined by various photography mode settings 175, which are typically associated with photography modes that can be selected via the user controls 34, which enable the user to adjust various camera settings 185 in response to menus displayed on the image display 32.

The color sensor data 100 which has been digitally converted by the ASP and A/D converter 16 is manipulated by a white balance step 95. In some embodiments, this processing can be performed using the methods described in commonly-assigned U.S. Pat. No. 7,542,077 to Miki, entitled “White balance adjustment device and color identification device”, the disclosure of which is herein incorporated by reference. The white balance can be adjusted in response to a white balance setting 90, which can be manually set by a user, or which can be automatically set by the camera.

The color image data is then manipulated by a noise reduction step 105 in order to reduce noise from the image sensor 14. In some embodiments, this processing can be performed using the methods described in commonly-assigned U.S. Pat. No. 6,934,056 to Gindele et al., entitled “Noise cleaning and interpolating sparsely populated color digital image using a variable noise cleaning kernel,” the disclosure of which is herein incorporated by reference. The level of noise reduction can be adjusted in response to an ISO setting 110, so that more filtering is performed at higher ISO exposure index setting.

The color image data is then manipulated by a demosaicing step 115, in order to provide red, green and blue (RGB) image data values at each pixel location. Algorithms for performing the demosaicing step 115 are commonly known as color filter array (CFA) interpolation algorithms or “deBayering” algorithms. In one embodiment of the present invention, the demosaicing step 115 can use the luminance CFA interpolation method described in commonly-assigned U.S. Pat. No. 5,652,621, entitled “Adaptive color plane interpolation in single sensor color electronic camera,” to Adams et al., the disclosure of which is incorporated herein by reference. The demosaicing step 115 can also use the chrominance CFA interpolation method described in commonly-assigned U.S. Pat. No. 4,642,678, entitled “Signal processing method and apparatus for producing interpolated chrominance values in a sampled color image signal”, to Cok, the disclosure of which is herein incorporated by reference.

In some embodiments, the user can select between different pixel resolution modes, so that the digital camera can produce a smaller size image file. Multiple pixel resolutions can be provided as described in commonly-assigned U.S. Pat. No. 5,493,335, entitled “Single sensor color camera with user selectable image record size,” to Parulski et al., the disclosure of which is herein incorporated by reference. In some embodiments, a resolution mode setting 120 can be selected by the user to be full size (e.g. 3,000×2,000 pixels), medium size (e.g. 1,500×1000 pixels) or small size (750×500 pixels).

The color image data is color corrected in color correction step 125. In some embodiments, the color correction is provided using a 3×3 linear space color correction matrix, as described in commonly-assigned U.S. Pat. No. 5,189,511, entitled “Method and apparatus for improving the color rendition of hardcopy images from electronic cameras” to Parulski, et al., the disclosure of which is incorporated herein by reference. In some embodiments, different user-selectable color modes can be provided by storing different color matrix coefficients in firmware memory 28 of the digital camera 10. For example, four different color modes can be provided, so that the color mode setting 130 is used to select one of the following color correction matrices:

### Setting 1 (Normal Color Reproduction)

$$[ \begin{matrix}{R}_{out} \\ {G}_{out} \\ {B}_{out}\end{matrix} ] = [ \begin{matrix}1.50 & - 0.30 & - 0.20 \\ - 0.40 & 1.80 & - 0.40 \\ - 0.20 & - 0.20 & 1.40\end{matrix} ] [ \begin{matrix}{R}_{in} \\ {G}_{in} \\ {B}_{in}\end{matrix} ] \qquad ( 1 )$$

### Setting 2 (Saturated Color Reproduction)

$$[ \begin{matrix}{R}_{out} \\ {G}_{out} \\ {B}_{out}\end{matrix} ] = [ \begin{matrix}2.00 & - 0.60 & - 0.40 \\ - 0.80 & 2.60 & - 0.80 \\ - 0.40 & - 0.40 & 1.80\end{matrix} ] [ \begin{matrix}{R}_{in} \\ {G}_{in} \\ {B}_{in}\end{matrix} ] \qquad ( 2 )$$

### Setting 3 (De-Saturated Color Reproduction)

$$[ \begin{matrix}{R}_{out} \\ {G}_{out} \\ {B}_{out}\end{matrix} ] = [ \begin{matrix}1.25 & - 0.15 & - 0.10 \\ - 0.20 & 1.40 & - 0.20 \\ - 0.10 & - 0.10 & 1.20\end{matrix} ] [ \begin{matrix}{R}_{in} \\ {G}_{in} \\ {B}_{in}\end{matrix} ] \qquad ( 3 )$$

### Setting 4 (Monochrome)

$$[ \begin{matrix}{R}_{out} \\ {G}_{out} \\ {B}_{out}\end{matrix} ] = [ \begin{matrix}0.30 & 0.60 & 0.10 \\ 0.30 & 0.60 & 0.10 \\ 0.30 & 0.60 & 0.10\end{matrix} ] [ \begin{matrix}{R}_{in} \\ {G}_{in} \\ {B}_{in}\end{matrix} ] \qquad ( 4 )$$

In other embodiments, a three-dimensional lookup table can be used to perform the color correction step 125.

The color image data is also manipulated by a tone scale correction step 135. In some embodiments, the tone scale correction step 135 can be performed using a one-dimensional look-up table as described in U.S. Pat. No. 5,189,511, cited earlier. In some embodiments, a plurality of tone scale correction look-up tables is stored in the firmware memory 28 in the digital camera 10. These can include look-up tables which provide a “normal” tone scale correction curve, a “high contrast” tone scale correction curve, and a “low contrast” tone scale correction curve. A user selected contrast setting 140 is used by the processor 20 to determine which of the tone scale correction look-up tables to use when performing the tone scale correction step 135.

The color image data is also manipulated by an image sharpening step 145. In some embodiments, this can be provided using the methods described in commonly-assigned U.S. Pat. No. 6,192,162 entitled “Edge enhancing colored digital images” to Hamilton, et al., the disclosure of which is incorporated herein by reference. In some embodiments, the user can select between various sharpening settings, including a “normal sharpness” setting, a “high sharpness” setting, and a “low sharpness” setting. In this example, the processor 20 uses one of three different edge boost multiplier values, for example 2.0 for “high sharpness”, 1.0 for “normal sharpness”, and 0.5 for “low sharpness” levels, responsive to a sharpening setting 150 selected by the user of the digital camera 10.

The color image data is also manipulated by an image compression step 155. In some embodiments, the image compression step 155 can be provided using the methods described in commonly-assigned U.S. Pat. No. 4,774,574, entitled “Adaptive block transform image coding method and apparatus” to Daly et al., the disclosure of which is incorporated herein by reference. In some embodiments, the user can select between various compression settings. This can be implemented by storing a plurality of quantization tables, for example, three different tables, in the firmware memory 28 of the digital camera 10. These tables provide different quality levels and average file sizes for the compressed digital image file 180 to be stored in the image memory 30 of the digital camera 10. A user selected compression mode setting 160 is used by the processor 20 to select the particular quantization table to be used for the image compression step 155 for a particular image.

The compressed color image data is stored in a digital image file 180 using a file formatting step 165. The image file can include various metadata 170. Metadata 170 is any type of information that relates to the digital image, such as the model of the camera that captured the image, the size of the image, the date and time the image was captured, and various camera settings, such as the lens focal length, the exposure time and f-number of the lens, and whether or not the camera flash fired. In a preferred embodiment, all of this metadata 170 is stored using standardized tags within the well-known Exif-JPEG still image file format. In a preferred embodiment of the present invention, the metadata 170 includes information about various camera settings 185, including the photography mode settings 175.

The present invention will now be described with reference to FIGS. 3 and. 4. FIG. 3 shows a flowchart illustrating a method for processing an input audio signal 200 to produce a digital representation of the input audio signal 200 suitable for storing in a digital audio file 290. In a preferred embodiment, the input audio signal 200 is captured by one or more microphones 24 (FIG. 1) attached directly to the digital camera 10. In alternate embodiments, the input audio signal 200 may be captured using one or more external microphones, or other sound gathering devices, that are connected to the digital camera 10 using a wired connection through an audio jack or using a wireless connection.

Processing of the input audio signal 200 includes various analog and digital processing operations to condition the input audio signal 200 for the digital imaging architecture, and to improve the quality of the input audio signal 200. It is understood that the order of operations may vary depending on the desired implementation. Also, the nature and capabilities of the operations may vary depending on cost, quality and architecture considerations.

An amplifier operation 210 is used to amplify the input audio signal 200 to adjust its amplitude as required for downstream processing components. In some embodiments, the amplifier operation 210 can apply a fixed amount of gain. In a preferred embodiment, the amount of gain applied is determined by an automatic gain control based on the signal level of the input audio signal 200. In some embodiments, the performance of the amplifier operation 210 can be adjusted responsive to the scene type.

In some embodiments, the analog audio signal is preconditioned by an analog filter operation 220. Typically, the analog filter operation 220 applies a low-pass filter designed to eliminate high-frequency components that could cause aliasing, as well as high-frequency noise. The analog filter operation 220 can also be used to band-limit the analog audio signal to remove low-frequency sub-sonic components that can interfere with various audio processing operations. In some embodiments, the analog filter operation 220 may also include analog filters that target different frequencies to condition the analog audio signal as appropriate to the recording environment or to account for specific hardware limitations (e.g., to filter out noise from lens movement or other noise sources having known frequencies).

It is well known in the art of audio recording that controlling the dynamics of the audio signal is desirable to create an optimal audio recording. A dynamic processing operation 230 is used to adjust the dynamics of the analog audio signal. The dynamic processing operation 230 can include an expander to increase the dynamic range of the audio signal or a compressor to reduce the dynamic range of the audio signals in order to provide a signal that will not be distorted by clipping and matches the dynamic range of the analog audio signal to that required for digitization. The dynamic processing operation 230 can also include an audio limiter function that restricts the audio signal to a specified dynamic range, or a noise gate function that sets audio signal amplitudes below a specified threshold to zero, thereby reducing background noise.

The dynamic processing operation 230 may utilize one or more parameters or options specified by dynamic processing settings 232 to obtain the desired signal shaping. The dynamic processing settings 232 can be used to control the behavior of the amplifier operation 210, as well as the dynamic processing operation 230. The dynamic processing settings 232 are a subset of a larger set of audio mode settings 285. The audio mode settings 285 may be associated with various camera settings 185, which can be either automatically adjusted or can be selected using the user controls 34 (FIG. 1). As will be described in more detail later, in a preferred embodiment, one or more of the audio mode settings 285 are adjusted depending on a scene type associated with the scene being photographed.

An analog-to-digital (A/D) conversion operation 240 is used to digitize the analog audio signal, providing a digitized audio signal. The A/D conversion operation 240 typically includes a sample-and-hold function, together with a quantization function. Various hardware components for providing the A/D conversion operation 240 are widely available, and can be chosen to provide digitized audio signals of various bit depths and sampling frequencies. Typically, the audio signal is digitized with a bit depth between 8 to 24 bits, and sampled with a sampling frequency between 8 to 96 kHz.

In some embodiments, some or all of the functions performed by the amplifier operation 210, the analog filter operation 220 and the dynamic processing operation 230 can be applied to the digitized audio signal after the A/D conversion operation rather than to the analog audio signal. However, in this case it is typically necessary to digitize the audio signal to a higher bit-depth, and possibly a higher sampling frequency, in order to provide adequate quality.

A matrixing operation 250 can be used to compute a linear combination of audio signals from multiple microphones to improve the fidelity or clarity of the resulting audio signal. The matrixing operation 250 uses matrixing settings 252, which specify matrix coefficients (i.e., scale values) for each audio signal being combined. It is known that matrixing can be done in either an analog or digital domain. FIG. 3 describes an embodiment where the matrixing operation 250 is done in the digital domain. Matrixing can be used to either include ambient sounds or make the recording more directional. For example in an exemplary embodiment, a camera can have a second microphone mounted on the back of the camera to supplement a first microphone mounted on the front of the camera. When the signal from the rear microphone is added to the signal from the front microphone, sounds from the rear of the camera are added to the recording. When a portion of the signal from the rear microphone is subtracted from the signal from the front microphone, ambient sounds are reduced. This type of matrixing would be appropriate for use when the scene type is classified as “Portrait,” containing a single speaker.

To improve the purity of the digital audio signal, many embodiments provide a noise reduction operation 261. In a preferred embodiment, the noise reduction operation 261 uses a simple linear filter. For example, the noise reduction operation 261 can be used to filter out one or more frequencies associated with the camera lens motor 8 (FIG. 1) during focus or zoom operations. Another application can be to suppress frequencies associated with noise caused by wind blowing into the microphone for outdoor scene types (e.g., beach scenes). In other embodiments, the noise reduction operation 261 may be a non-linear operation such as a noise gate operation. In a preferred embodiment, various noise reduction settings 262 used for the noise reduction operation 261 are adjusted based on the determined scene type.

Further frequency conditioning may be applied using a signal shaping operation 265 to enhance the overall quality of the digital audio signal. For example, the signal shaping operation 265 can be used to amplify or deemphasize certain frequencies due to characteristics of the recording environment or for purely aesthetic reasons. Signal shaping settings 266 for the signal shaping operation 265 are supplied according the desired effects. In a preferred embodiment, different equalization filters are provided that are optimized for use with different scene types. It is understood that the number of conditions and spectral designs are unlimited and constrained only by the imagination, creativity and skill of the filter designer.

For embodiments where the noise reduction operation 261 and the signal shaping operation 265 each involve simple linear filtering operations, these operations can be combined into a single equalization operation 260. As is known in the art, audio equalization processes provide selective enhancement/suppression of different audio frequencies. In this case, the noise reduction settings 262 and the signal shaping settings 266 can be combined into a single set of equalization settings 267. As will be discussed in more detail later, in a preferred embodiment of the present invention, the equalization settings 267 are adjusted responsive to the scene type to provide a processed audio signal that is optimized for the image capture conditions. It should be noted, that although FIG. 3 shows the equalization operation 260 being applied in the digital domain, it is known that equalization processes can be performed in either the analog or digital domain in various embodiments.

Next, the processed digital audio signal is encoded to produce a digital audio file 290. The encoding process generally includes an audio data compression operation 270 which is controlled using audio data compression settings 272 that dictate the file size/audio quality tradeoff. In some embodiments, the audio data compression settings 272 can be adjusted responsive to user “audio quality” controls, or can be adjusted responsive to a scene-type. For example, the audio signal for a concert scene can be recorded using a higher fidelity compression setting than would be necessary to record the audio signal for a sports scene.

The audio data compression operation 270 is followed by a file formatting operation 280, which creates the digital audio file 290. Typically, a standard audio file format will be used to encode the compressed audio signal in the digital audio file 290. Those skilled in the art will recognize that several competing audio file format standards exist, and that the actual embodiment used is purely a camera design decision. Various metadata 282, including metadata relating to the camera settings 185, the audio mode settings 285 or the determined scene type may be included as part of the digital audio file 290.

In a preferred embodiment, the digital audio file 290 is written to an internal digital memory, or saved on a digital camera memory card.

Alternately, the digital audio file 290 can be transmitted to an external storage memory (e.g., using a wired or wireless connection). In some embodiments, the digital audio file 290 is included as part of a digital image file (e.g., as audio metadata) or as part of a digital video file (e.g., as an associated audio track). In other embodiments, the digital audio file 290 can be stored as a separate file. If the digital audio file 290 is stored as a separate file, it will typically be associated with a particular digital image file or digital video file that was captured at the same time that the input audio signal 200 was captured.

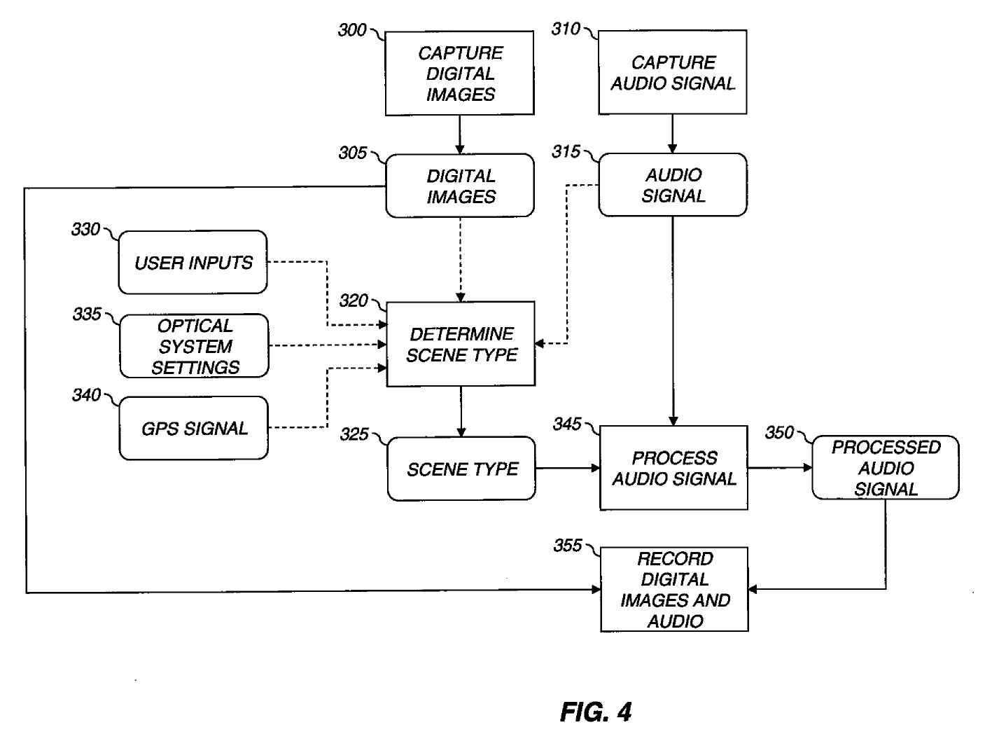

FIG. 4 shows a flow chart of a method for processing digital image data and audio signal data according to the present invention. In a preferred embodiment, the method described in FIG. 4 is embodied in a digital camera 10, which can be a digital still camera or a digital video camera. In some embodiments, some or all of the steps shown in FIG. 4 are performed using a processor 20 (FIG. 1) within the digital camera 10. In this case, instructions for causing the processor 20 to execute the steps of the present invention can be stored in a program memory (e.g., firmware memory 28). In other embodiments, the digital image data and the audio signal data can be passed to an external system where some, or all, of the processing steps can be applied. For example, the processing can be performed on a personal computer or a network server.

A capture digital images step 300 is used to capture one or more digital images 305 with the image sensor 14 (FIG. 1), and a capture audio signal step 310 is used to capture an associated audio signal 315 with the microphone 24 (FIG. 1). The digital images 305 will typically be processed according to the imaging chain shown in FIG. 2, or some variation thereof.

In some embodiments, the digital images 305 are digital still images. In such cases, the audio signal 315 can serve various purposes. For example, the audio signal 315 can be audio annotation provided by the photographer, or can be an audio signal captured of the photography environment at the time that the digital images 305 were captured.

In other embodiments, the digital images can be a plurality of video frames associated with a digital video sequence captured by a digital video camera (or a digital still camera having an optional video capture mode). In such cases, the audio signal 315 will typically be an audio track associated with the digital video sequence.

A determine scene type step 320 is used to determine a scene type 325 corresponding to the captured digital images 305. In various embodiments, the determine scene type step 320 determines the scene type 325 responsive to user inputs 330, optical systems settings 335, a GPS signal 340 obtained using GPS sensor 25 (FIG. 1), the digital images 305, the audio signal 315, or combinations thereof.

A process audio signal step 345 is used to process the audio signal 315 responsive to the scene type 325, forming a processed audio signal 350. In a preferred embodiment, the process audio signal step 345 uses the audio processing method described with reference to FIG. 3, or some variation thereof. In some embodiments, only a subset of the processing operations may be used, or the order of the processing operations may be changed. The audio processing applied by the process audio signal step 345 is adjusted according to the scene type 325 to provide optimized performance. Typically, the audio processing is adjusted by controlling the various audio mode settings 285 (FIG. 3). Finally, a record digital images and audio step 355 is used to record the digital images 305 and the processed audio signal 350 in a processor accessible memory, for example in a digital video file.

The various steps in the method of FIG. 4 will now be described in more detail. The determine scene type step 320 can use any method known in the art to determine the scene type 325. In a preferred embodiment, the scene type 325 is determined automatically by analyzing various pieces of information pertaining to the captured digital images 305 and audio signal 315.

In some embodiments, the determine scene type step 320 utilizes the scene-type determination method disclosed in U.S. Pat. No. 7,761,000, to Nakajima, entitled “Imaging device,” which is incorporated herein by reference. This method involves analyzing various information including scene brightness, subject distance, and face detection reliability to determine a scene type for the purpose of automatically setting a photography mode.

In some embodiments, the determine scene type step 320 determine the scene type 325, at least in part, by analyzing the digital images 305. In some cases, the digital images 305 that are analyzed can be the captured digital images that are going to be stored in the digital image file 180 (FIG. 2) In other cases, the digital images 305 can be preview images captured before the user initiates the image capture process. For example, semantic classifiers are known in the art that can be used to classify digital images according to various semantic concepts.

Some semantic classifiers analyze digital images to classify them according to certain scene type categories, such as indoor, beach, sky, outdoor, mountain or nature. Details of exemplary scene classifiers that can be used in accordance with the present invention are described in U.S. Pat. No. 6,282,317 entitled “Method for automatic determination of main subjects in photographic images”; U.S. Pat. No. 6,697,502 entitled “Image processing method for detecting human figures in a digital image assets”; U.S. Pat. No. 6,504,951 entitled “Method for Detecting Sky in Images”; U.S. Patent Application Publication 2005/0105776 entitled “Method for Semantic Scene Classification Using Camera Metadata and Content-based Cues”; U.S. Patent Application Publication 2005/0105775 entitled “Method of Using Temporal Context for Image Classification”; and U.S. Patent Application Publication 2004/0037460 entitled “Method for Detecting Objects in Digital images, each of which is incorporated herein by reference.

Other types of semantic classifiers analyze digital images to classify them according to an event type, such as party, vacation, sports or family moment. An example of a typical event recognition algorithm that can be used in accordance with the present invention can be found in commonly assigned co-pending U.S. Patent Application Publication 2008/273600, entitled “Method for Event-Based Semantic Classification,” which is incorporated herein by reference.

Other types of image analysis algorithms can also be used to analyze the digital images 305 in order to provide information useful for determining the scene type. In some embodiments, the digital images can be analyzed to determine various lightness, color, and texture characteristics of the scene. For example, a large area of blue at the top of the digital image would be characteristic of sky and thus indicate an outdoor scene.

In some embodiments, the determine scene type step 320 can include analyzing the audio signals 315 to detect audio content associated with certain scene types. For example, if wind sounds are detected, it can be inferred that the digital camera is capturing images of an outdoor scene, or if echo sounds are detected, it can be inferred that the digital camera is capturing images in a large room. Likewise, if crowd noises are detected, it can be inferred that the digital camera is capturing images of a sports scene, or if music is detected, it can be inferred that the digital camera 10 is capturing images at a concert.

In some embodiments, geographical information determined by the GPS sensor 25 can be used to infer a scene type 325. For example, co-pending, commonly-assigned U.S. patent application Ser. No. 12/769,680 to Prentice et al., entitled “Indoor/outdoor scene detection using GPS,” which is incorporated herein by reference, teaches various methods to determine information about a scene type responsive to a global positioning system signal. In addition to determining whether the digital camera is being operated indoors or outdoors, Prentice et al. teach that the GPS signal can be analyzed, together with time and date information, to determine whether the digital camera is being used to photograph a sunset or a snow scene, or whether the digital camera is being operated at a known location such as a theater, a museum or a public building. Likewise, the GPS signal could also be used to determine whether the digital camera is being operated at a beach, a park, a ski resort or a sports arena. Such information can be used to determining an appropriate scene type 325.

In some embodiments, various optical system settings 335, such as a scene brightness, a lens aperture setting, a lens zoom position, a lens focus distance, or information from an image stabilization system, can be used by the determine scene type step 320 in the process of determining the scene type 325.

For example, a large lens focus distance can be used to infer that the scene may be an outdoor scene or a stage scene but is unlikely to be an indoor home scene. Combining the lens focus distance data with a detected scene brightness and a detected scene illumination type (e.g., tungsten or daylight) can further make the distinction between an outdoor scene and a stage scene. Similarly, the zoom position provides additional information that can be used to determine the scene type 325. For example, high zoom factors are more likely to indicate outdoor scenes or sports scenes.

In some embodiments, the determine scene type step 320 can use user inputs 330 provided using the user controls 34 (FIG. 1) in the process of determining the scene type 325. For example, a user may select a photography mode from a photography mode menu. Most user-selectable photography modes can be associated with an appropriate scene type 325 (e.g., the selection of the “sports” photography mode can be used to infer that the scene type 325 is a sports scene). Alternately, rather than using a photography mode menu, any type of user control 34 known in the art can be used to specify a photography mode. Typical user controls 34 would include dial selectors, button selectors and voice-activated controls.

In some embodiments, the determine scene type step 320 can use only a single type of input (e.g., user inputs 330) in the process of determining the scene type 325. In other embodiments the determine scene type step 320 determines the scene type 325 by considering multiple types of input data. Those skilled in the art will recognize that multiple inputs can be combined to increase the probability of determining the most appropriate scene type 325. For example, information from semantic classification algorithms can be combined with analysis of the audio signal 315 and various optical system settings 335 to provide a more reliable scene type determination. In one embodiment, a set of training data can be collected for a large number of images. The scene types for the images in the training set can be manually determined. A statistical classifier can then be trained to predict the scene type 325 as a function of the collected inputs. Any type of statistical classifier known in the art can be used, including Bayesian classifiers and neural network classifiers.

In a preferred embodiment, the determine scene type step 320 selects a scene type 325 from a set of predefined scene types. The predefined scene types can include scene types such as indoor scene, outdoor scene, beach scene, snow scene, candlelight scene, fireworks scene, portrait scene, stage scene, sports scene, landscape scene or macro scene.

Typically, the process audio signal step 345 will process the audio signal 315 using the process discussed relative to FIG. 3, or some variation thereof. In a preferred embodiment, the characteristics of the process audio signal step 345 are adjusted responsive to the scene type 325 by adjusting one or more of the audio mode settings 285 in order to achieve an optimized recording specific to the scene type 325. For the case where the scene type 325 is selected from a predefined set of scene types, a set of audio mode settings 285 can be defined to be used with each of the predefined scene types. The set of audio mode settings 285 can be stored in a digital memory and can be loaded in response to the determined scene type 325.

In many cases, it will be desirable to adjust the performance of the dynamic processing operation 230 and the equalization operation 260 according to the determined scene type 325 (although other operations can also be adjusted in some embodiments). This can be done by providing different sets of dynamic processing settings 232 and equalization settings 267 that are optimized for each of the predefined scene types. Table 1 shows a set of exemplary scene types 325, together with example audio processing strategies.

TABLE 1
Example scene-type-dependent audio processing strategies.

| | Audio | Dynamics | |
|---|---|---|---|
| | Processing | Processing | Equalization |
| Scene Type | Strategy | Settings | Settings |
| Beach | Enhance wave | Use compressor to | Reduce mid- |
| (general) | sounds | preferentially | frequencies, boost |
| | | amplify | low-frequency |
| | | background | rumble and high |
| | | sounds | frequency wave |
| | | | crash |
| Beach | Isolate speech | Use automatic | Increase mid |
| (with face in | | gain control to | frequencies, reduce |
| foreground) | | normalize volume. | low and high |
| | | | frequencies to |
| | | | limit wave and wind |
| | | | noise |
| Snow | Restore high | Use compressor to | Boost high |
| | frequency | preferentially | frequencies |
| | sounds | amplify | |
| | absorbed by | background | |
| | snow | sounds | |
| Fireworks | Avoid clipping | Use limiter to | No adjustment |
| | due to high | avoid clipping | |
| | dynamic range | | |
| Portrait | Isolate speech | Use automatic | Increase mid |
| | | gain control to | frequencies, reduce |
| | | normalize volume. | low and high |
| | | | frequencies to |
| | | | limit wind and other |
| | | | noises |
| Stage | Enhance music | Use automatic | Increase low and |
| | and voice | gain control to | high frequencies to |
| | | normalize volume. | provide richer sound |
| Sports | Suppress | Use automatic | Increase mid |
| | background | gain control to | frequencies, reduce |
| | noise | normalize volume. | low and high |
| | | | frequencies to |
| | | | limit wind and other |
| | | | noise |
| Landscape | Enhance | Use compressor to | Increase mid and |
| | ambient | amplify | high frequencies, |
| | sounds | background | reduce low |
| | | sounds | frequencies to limit |
| | | | wind noise. |
| Macro | Reduce camera | Use noise gate to | Reduce extreme low |
| | handling noise | reduce camera | frequencies |
| | | handling noise | |

In other embodiments, not only can various audio mode settings 285 be adjusted responsive to the scene type 325, but additionally the set of processing steps in the audio processing chain can also be adjusted. For example, the order of the steps in the audio processing chain of FIG. 3 can be changed, or certain steps can be skipped altogether for certain scene types. In some embodiments, additional processing steps can be added or entirely different audio processing methods can be used depending on the scene type 325.

A computer program product can include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to certain preferred embodiments thereof, but it will be understood that variations and modifications can be effected within the spirit and scope of the invention.

### PARTS LIST

2 flash
4 lens
6 adjustable aperture and adjustable shutter
8 zoom and focus motor drives
10 digital camera
12 timing generator
14 image sensor
16 ASP and A/D Converter
18 buffer memory
20 processor
22 audio codec
24 microphone
25 GPS sensor
26 speaker
28 firmware memory
30 image memory
32 image display
34 user controls
36 display memory
38 wired interface
40 computer
44 video interface
46 video display
48 interface/recharger
50 wireless modem
52 radio frequency band
58 wireless network
70 Internet
72 photo service provider
90 white balance setting
95 white balance step
100 color sensor data
105 noise reduction step
110 ISO setting
115 demosaicing step
120 resolution mode setting
125 color correction step
130 color mode setting
135 tone scale correction step
140 contrast setting
145 image sharpening step
150 sharpening setting
155 image compression step
160 compression mode setting
165 file formatting step
170 metadata
175 photography mode settings
180 digital image file
185 camera settings
200 input audio signal
210 amplifier operation
220 analog filter operation
230 dynamic processing operation
232 dynamic processing settings
240 A/D conversion operation
250 matrixing operation
252 matrixing settings
260 equalization operation
261 noise reduction operation
262 noise reduction settings
265 signal shaping operation
266 signal shaping settings
267 equalization settings
270 audio data compression operation
272 audio data compression settings
280 file formatting operation
282 metadata
285 audio mode settings
290 digital audio file
300 capture digital images step
305 digital images
310 capture audio signal step
315 audio signal
320 determine scene type step
325 scene type
330 user inputs
335 optical system settings
340 GPS signal
345 process audio signal step
350 processed audio signal
355 record digital images and audio step

1. A digital camera system providing processed audio signals, comprising:
an image sensor for capturing a digital image;
an optical system for forming an image of a scene onto the image sensor;
a microphone for capturing an audio signal;
a data processing system;
a storage memory for storing captured images and audio signals; and
a program memory communicatively connected to the data processing system and storing instructions configured to cause the data processing system to implement a method for providing processed audio signals, wherein the instructions include:
capturing one or more digital images of a scene using the image sensor and capturing a corresponding audio signal using the microphone;
determining a scene type corresponding to the captured digital images;
processing the captured audio signal responsive to the determined scene type; and
recording the captured digital images together with the processed audio signal in the storage memory.

2. The digital camera system of claim 1 wherein the digital camera system is a digital video camera or a digital still camera capable of capturing digital video sequences.

3. The digital camera system of claim 2 wherein the captured digital images are video frames for a digital video sequence and the audio signal is an audio track corresponding to the digital video sequence.

4. The digital camera system of claim 1 wherein the captured digital images are digital still images.

5. The digital camera system of claim 1 wherein the scene type is selected from a plurality of predefined scene types.

6. The digital camera system of claim 5 wherein the predefined scene types include beach scene, snow scene, candlelight scene, fireworks scene, portrait scene, stage scene, sports scene, landscape scene or macro scene.

7. The digital camera system of claim 1 wherein the digital camera system further includes a user interface, and wherein the scene type is determined responsive to a user input provided using the user interface.

8. The digital camera system of claim 1 wherein the scene type is automatically determined responsive to an analysis of the captured digital images.

9. The digital camera system of claim 8 wherein the analysis of the captured digital images includes applying a semantic classification algorithm.

10. The digital camera system of claim 1 wherein the scene type is automatically determined responsive to an analysis of the captured audio signal.

11. The digital camera system of claim 1 wherein the scene type is automatically determined responsive to optical system settings.

12. The digital camera system of claim 5 wherein the optical system settings include a scene brightness value, a lens aperture setting, a lens zoom position or a lens focus distance.

13. The digital camera system of claim 1 further including a global position system receiver, wherein the determination of the scene type is further responsive to a signal from the global position system receiver.

14. The digital camera system of claim 1 further including a real time clock, wherein the determination of the scene type is further responsive to a date and time determined using the real time clock.

15. The digital camera system of claim 1 wherein the audio signal is processed by applying an audio equalization process responsive to the determined scene type.

16. The digital camera system of claim 1 wherein the audio signal is processed by applying a dynamic range adjustment process responsive to the determined scene type.

17. The digital camera system of claim 1 wherein the audio signal is processed by applying an audio limiter responsive to the determined scene type.

18. The digital camera system of claim 1 wherein the audio signal is processed by applying an audio noise reduction process responsive to the determined scene type.

19. The digital camera system of claim 17 wherein the audio noise reduction process includes an audio noise gate process.

20. The digital camera system of claim 1 wherein the audio signal is processed by applying an audio data compression process responsive to the determined scene type.

21. The digital camera system of claim 20 wherein a compression rate associated with the audio data compression process is adjusted responsive to the determined scene type.

22. The digital camera system of claim 1 further including at least one additional microphone for capturing at least one additional audio signal, wherein a matrixing operation is used to combine the audio signals, and wherein the matrixing operation is adjusted responsive to the determined scene type.

23. The digital camera system of claim 1 wherein the microphone is an external microphone connected to the digital camera system.

24. The digital camera system of claim 1 wherein the data processing system is an external data processing system communicably connected to other components of the digital camera system.

25. A method for processing audio signals captured using a digital camera, comprising:
receiving one or more digital images of a scene captured with the digital camera;
receiving an audio signal corresponding to the captured digital images;
determining a scene type corresponding to the captured digital images;
using a data processor to process the captured audio signal responsive to the determined scene type thereby providing a processed audio signal; and
recording the captured digital images together with the processed audio signal in a processor-accessible memory.
